(19) United States
(12) Patent Application Publication
(10) Pub. No.: US 2005/0216153 A1
(43) Pub. Date: Sep. 29, 2005

(54) Vehicle key having memory and vehicle control method using the same

(75) Inventor: Beom-Soo Cho, Gwacheon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/939,688

(22) Filed: Sep. 13, 2004

(30) Foreign Application Priority Data
Mar. 4, 2004 (KR) 14601-2004

(51) Int. Cl. G06F 7/00

(52) U.S. Cl. 701/35; 701/1

(57) ABSTRACT

A vehicle key having a memory and a vehicle control method using the vehicle key is disclosed. The memory stores control information for management and control of the vehicle, and the vehicle includes a memory reader/writer in an ignition control. If the vehicle detects the vehicle memory key through the memory reader/writer, it loads control information from the vehicle memory key. Additional services provided in the vehicle are controlled using the control information. This maximizes the user's satisfaction with the additional services provided in the vehicle and also provides an improved driving environment to the driver. This induces the driver to safely drive and decreases accident risk due to manipulation of equipment in the vehicle while driving, which consequently reduces traffic accident rates.

### PRIORITY

This application claims priority to an application entitled “VEHICLE KEY HAVING MEMORY AND VEHICLE CONTROL METHOD USING THE SAME”, filed in the Korean Intellectual Property Office on Mar. 4, 2004 and assigned Serial No. 2004-14601, the contents of which are incorporated herein by reference.

### BACKGROUND OF THE INVENTION

1. Field of the Invention

The present invention relates to a vehicle key having a memory and a vehicle control method using the vehicle key, and more particularly to a vehicle key for storing vehicle control information including vehicle travel information and vehicle component setting information, and a vehicle control method using the vehicle key.

2. Description of the Related Art

Initially, vehicles such as cars functioned merely to transport persons to their destinations. As demand for additional functions (for example, telematics) of the vehicle allow the vehicle to receive various information and to provide entertainment inside the vehicle has gradually increased, the number of types of the additional functions has considerably increased. Optimization of the additional services provided in the vehicle according to user interests or preferences can maximize the users' satisfaction. For example, storing a user's favorite radio station frequencies via preset buttons in a radio installed in a vehicle makes it easy for the user to select the favorite frequencies.

Most recently, certain vehicles allow functions to be previously set to desired state values for various components of the vehicle according to physical dimensions and driving habits of the driver, to allow automatic adjustment of the components according to their set values. For example, some vehicles allows users to set and control their own driving environments simply by pushing one button after inputting their desired values of vehicle component states, such as the distance between the driver's seat and steering wheel, the height of the steering wheel, the position of the seat back and inclination angle of rearview and side mirrors.

In a vehicle having a navigation system, information of previous routes or frequently traveled routes of the vehicle is stored in the navigation system using vehicle usage history of the driver, and a route guidance service is provided to the driver using the stored information.

Such conventional systems, however, do not provide a method for device for integrating and managing such information of the additional services provided in the vehicle.

An apparatus and method for automatically managing travel record information of a vehicle (for example, travel speed records, and brake and blinker operation records) produced when the vehicle is in motion, or vehicle diagnostic information (for example, oil level, travel distance, engine temperature and battery voltage) has also not been provided by conventional systems.

Such vehicle travel information, for example, travel speed records, and brake and blinker operation records, is very useful for allocating responsibility for a traffic accident that occurs when a vehicle is in motion. Such allocation of responsibility is usually based only on the driver's memory and inspection of the site where the accident occurred.

In addition, the vehicle diagnostic information (for example, engine operating states, temperature and abnormal battery state indications) detectable by an Engine Control Unit (ECU) is checked only by display of information on a dashboard, by engine sound or by driver intuition.

### SUMMARY OF THE INVENTION

Therefore, the present invention has been made in view of the above shortcomings of conventional systems, and it is an object of the present invention to provide a device and method for improving the driving environment and conditions for vehicle drivers.

It is another object of the present invention to provide a device and method for maximizing satisfaction for the driver with additional services provided in a vehicle.

It is a further object of the present invention to provide a device and method for integrating and managing information of additional services provided in a vehicle.

It is another object of the present invention to provide a device and method for automatically managing travel record information or diagnostic information of a vehicle.

It is yet another object of the present invention to provide a device and method for automatically managing travel record information or diagnostic information of a vehicle while integrating and managing information of additional services provided in the vehicle.

In accordance with one aspect of the present invention, the above and other objects can be accomplished by providing a vehicle key including a memory for storing control information for management and control of a vehicle. Preferably, the control information includes user information including basic personal information and driver's license information; information of an additional service provided in the vehicle, said service being controllable based on the control information; travel record information of the vehicle; and diagnostic information of the vehicle. The memory preferably stores a plurality of control information items of the control information corresponding to each of at least one user. Preferably, the memory is provided in the vehicle key at a predetermined portion thereof to be inserted in a vehicle ignition control.

In accordance with another aspect of the present invention, a method is provided for controlling a vehicle using a vehicle memory key including a memory for storing control information for management and control of the vehicle, said vehicle including a memory reader/writer in an ignition control, the method including detecting the vehicle memory key by the memory reader/writer and loading control information from the vehicle memory key, the control information being used to control an additional service provided in the vehicle; and controlling the additional service using the control information.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a diagram showing a vehicle key according to a first embodiment of the present invention;

FIG. 1B is a diagram showing a vehicle key according to a second embodiment of the present invention;

FIGS. 2A to 2C illustrate the structure of a memory embedded in the vehicle key according to the first and second embodiments of the present invention;

FIG. 3 is a block diagram illustrating how the vehicle key is used according to the first and second embodiments of the present invention;

FIG. 4 is a flow chart showing how components of a vehicle are automatically controlled using the vehicle key according to the first and second embodiments of the present invention;

FIG. 5 is a flow chart showing how vehicle travel information is managed using the vehicle key according to the first and second embodiments of the present invention; and

FIG. 6 is a flow chart showing how a navigator is used with reference to information stored in the vehicle key according to the first and second embodiments of the present invention.

### DETAILED DESCRIPTION OF THE PREFERRED EMBODIMENTS

Now, preferred embodiments of the present invention will be described in detail with reference to the annexed drawings. In the following description, a detailed description of known functions and configurations incorporated herein is omitted to avoid making the subject matter of the present invention unclear.

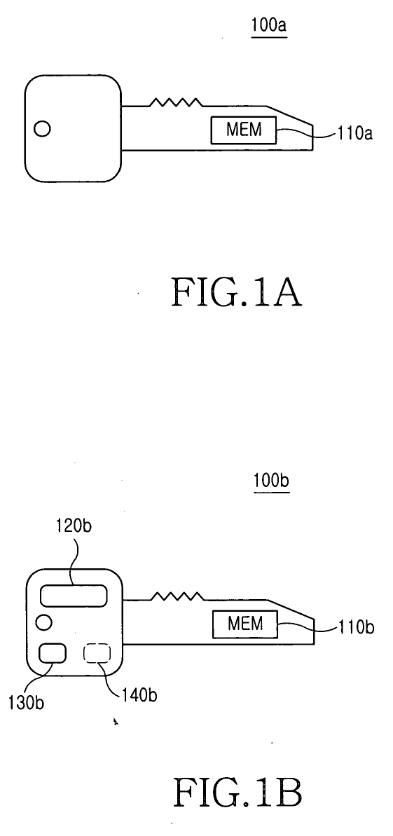

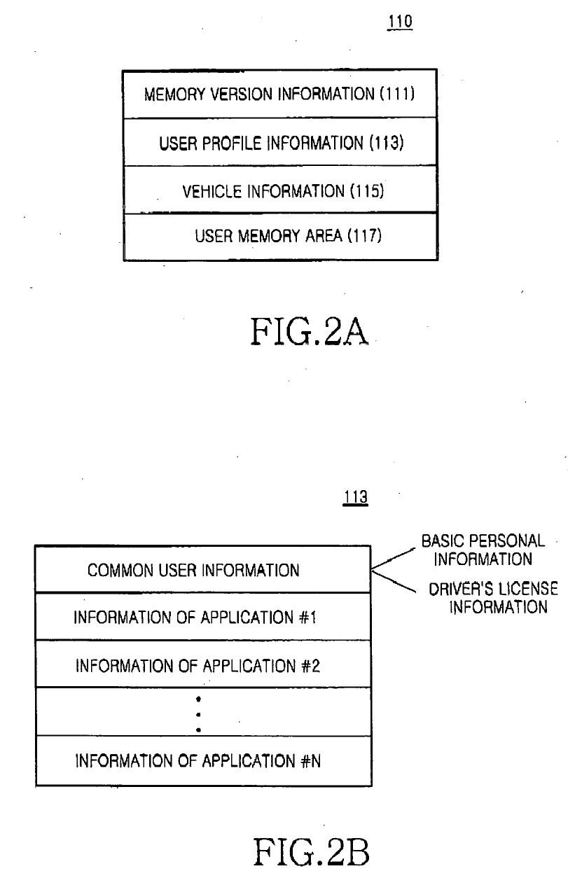

FIGS. 1A and 1B are diagrams showing vehicle keys according to first and second embodiments of the present invention, respectively.

As shown in FIG. 1A, a vehicle key 100a according to the first embodiment of the present invention includes a memory (MEM) 110a, which is embedded in the vehicle key 100a at a predetermined position thereof to be inserted into an ignition control of the vehicle. The memory 110a preferably includes information for managing respective information items of additional services provided in the vehicle and vehicle information such as vehicle travel records and vehicle diagnostic information.

As shown in FIG. 1B, a vehicle key 100b according to the second embodiment of the present invention includes a memory 110b, a display 120b, a selection button 130b and a power supply 140b. The memory 110b is embedded in the key 100b at a position thereof to be inserted into an ignition control of the vehicle.

Preferably, the memory 110b includes information for managing respective information items of additional services provided in a vehicle and vehicle information such as vehicle travel records and vehicle diagnostic information. The memory 110b further preferably includes user identification information for managing respective information items of additional services in a vehicle for each of a plurality of users.

The display 120b displays an information item selected by a user from among the information (for example, respective information items of additional services provided in a vehicle for each user) stored in the memory 110b. Preferably, the display 120b also displays, for example, user identification information corresponding to the selected information.

The user manipulates the selection button 130b to select an information item stored in the memory 110b. For example, the user preferably manipulates the selection button 130b to sequentially select the stored information items of the additional services provided for each user in the vehicle, with one item being selected each time the user presses the button 130b.

The power supply 140b supplies power to the vehicle key 100b to allow an information item stored in the memory 110b to be selected in the sequential order by the press of the selection button 130b and to display user identification information corresponding to the selected information item on the display 120b.

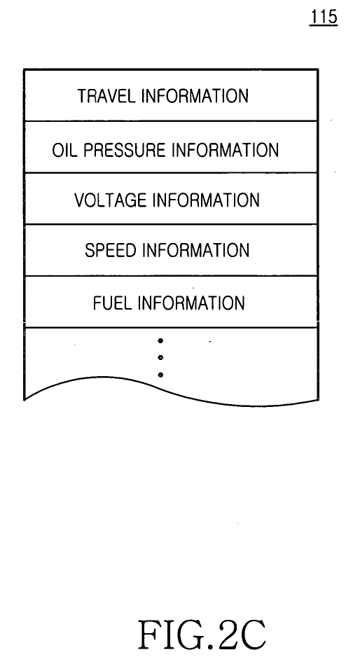

FIGS. 2A to 2C illustrate the structure of the memory embedded in the vehicle key according to the first and second embodiments of the present invention.

As shown in FIG. 2A, the memory 110a or 110b embedded in the vehicle key includes a memory version information field 111, a user profile information field 113, a vehicle information field 115 and a user memory area field 117.

The memory version information field 111 of the memory 110a or 110b stores version and equipment information of the memory for bi-directional interface.

The user profile information field 113 stores user information regarding applications and personal information of the user. Detailed examples of the information items stored in the user profile information field 113 are described below with reference to FIG. 2B.

The vehicle information field 115 stores vehicle travel records (for example, travel speed records and brake and blinker operation records) and vehicle diagnostic information (for example, oil level, travel distance, engine temperature and battery voltage).

The user memory area field 117 is used for a storage area of uploading information with application installed in a vehicle or downloading information generated in the application. For example, if the user wants to manage new route information made out in a computer by uploading the information to a navigator installed in the vehicle or to mange travel record information by downloading the information to the user's computer, the user stores such information in the memory area.

FIG. 2B provides an example of information items stored in the user profile information field 113 shown in FIG. 2A.

As shown in FIG. 2B, the user profile information field 113 includes common user information and application information of various applications (application #1 to application #N). This is basic information to be stored in the vehicle key having the memory embedded therein according to an embodiment of the present invention.

The common user information of a driver includes basic personal information (for example, name, gender, etc.) and driver's license information. The driver can modify the common user information via a memory interface installed in his/her personal computer.

The application information includes a list of applications satisfying a standardized interface of the vehicle key according to the embodiments of the present invention and information required for each of the applications. As with the common user information, the user can read and write the application information using his/her personal computer. The application information corresponding to an application can be automatically updated when the application is activated. The application list includes various information items of vehicle component states controllable based on the information stored in the vehicle key. Examples of the control information items are distance adjustment information between the driver and steering wheel, steering wheel height adjustment information, seat back location adjustment information and rearview/side mirror angle adjustment information. An information item of the application list is automatically updated when the driver changes a vehicle state corresponding to the information item manually or via a dedicated control key such as a button that controls a tilt angle or position of a vehicle seat or that controls a tilt angle of a side mirror.

FIG. 2C provides an example of information items stored in the vehicle information field 115 shown in FIG. 2A. The vehicle information field 115 includes vehicle travel information, such as travel speed records and brake and blinker operation records, and vehicle diagnostic information, such as oil pressure information, voltage information, speed information and fuel information. Preferably, these vehicle information items are received from an Engine Control Unit (ECU) in a vehicle, and are automatically stored in the memory at the vehicle information field 115.

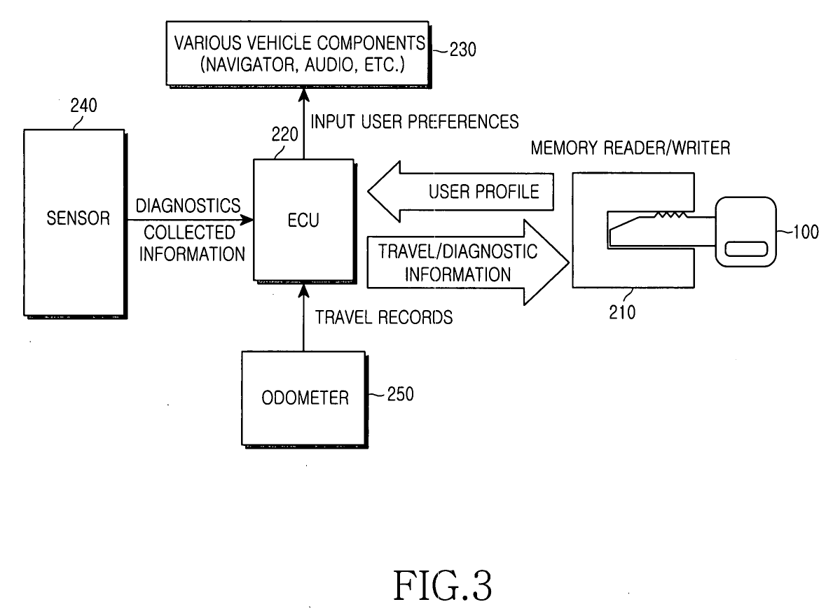

FIG. 3 is a block diagram illustrating how the vehicle key 100 is used according to the first and second embodiments of the present invention. As shown in FIG. 3, the vehicle key 100 according to the first and second embodiments of the present invention is inserted into an ignition control of in the vehicle. Information (for example, user profile information) stored in the memory embedded in the vehicle key 100 is read by a memory reader/writer 210 provided in the ignition control, and the read information is transferred to the vehicle. On the other hand, information (for example, vehicle travel/diagnostic information) collected by the engine control unit 220 in the vehicle is recorded in the memory embedded in the vehicle key 100.

When receiving information (for example, user profile information) read from the memory by the memory reader/writer 210, the engine control unit 220 obtains interests or preferences of the user based on the received information and transfers the interests or preferences of the user corresponding to various vehicle components 230 (for example, vehicle electronics or appliances such as a navigator and an audio system) and controls the corresponding vehicle components based on the user preferences.

The engine control unit 220 transfers vehicle collection information and vehicle diagnostics received from a sensor 240 (for example, a speed detector and/or a temperature detector) and vehicle travel records received from an odometer 250 to the memory reader/writer 210. Based on information transferred from the engine control unit 220, the memory reader/writer 210 updates the information of the vehicle key 100.

To operate in conjunction with the vehicle key in this manner, the vehicle includes the memory reader/writer 210 in the ignition control, which preferably makes electrical contact with the memory of the key 100.

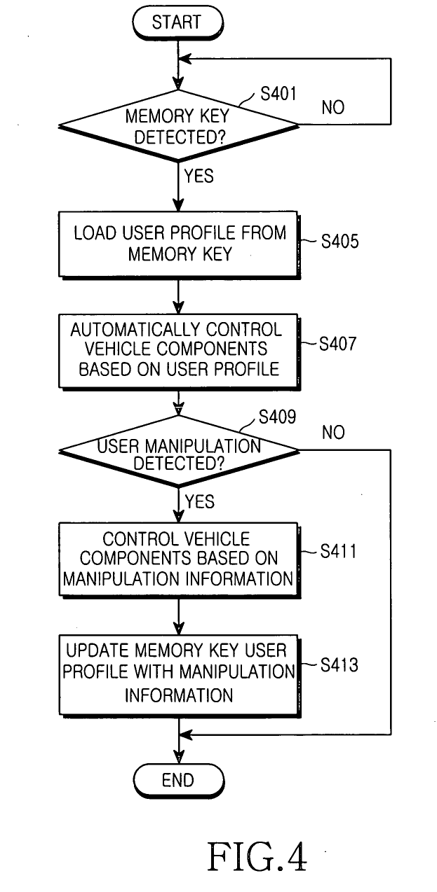

FIG. 4 is a flow chart showing how components of a vehicle are automatically controlled using the vehicle key (hereinafter referred to as a “memory key”) according to the first and second embodiments of the present invention. The automatic control of vehicle components using the memory key according to the present invention will now be described with reference to FIG. 4. If a memory reader/writer provided in a vehicle detects a memory key (S401), an engine control unit in the vehicle loads a user profile from the memory key (S405), and automatically controls vehicle components in the vehicle on the basis of the user profile (S407). For example, based on details of the user profile, the engine control unit adjusts the distance between the steering wheel and the driver's seat of the vehicle, the height of the steering wheel, the location of a seat back, the inclination angle of rearview and side mirrors, and the like.

If it is detected that the user manipulates a vehicle component, for example, manually or through a dedicated control key (S409), the engine control unit controls the component based on the manipulation (S411), and updates the user profile of the memory key with the manipulation information (S413). This update process is performed to automatically apply the manipulation information when the user uses the memory key to operate the vehicle at a later time.

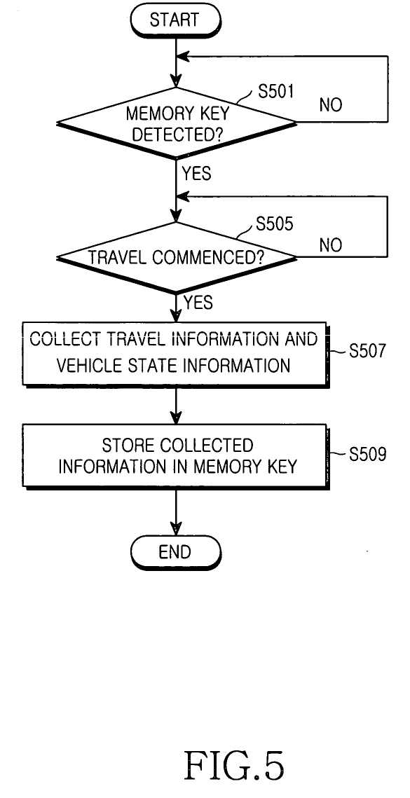

FIG. 5 is a flow chart showing how vehicle travel information is managed using a memory key according to the first and second embodiments of the present invention. The management of the vehicle travel information using the memory key according to the present invention will now be described with reference to FIG. 5. If a memory reader/writer provided in a vehicle detects a memory key (S501) and the vehicle starts to move (S505), the engine control unit in vehicle collects vehicle travel information (for example, travel speed records and brake and blinker operation records when the vehicle is in motion) and vehicle state information (for example, vehicle diagnostic information such as oil pressure information, voltage information, travel speed information and fuel information) as the vehicle travels (S507). The collected information is stored in the memory key (S509). The stored information can be used to investigate the cause of an accident that may occur when the vehicle is in motion, or the stored information can be used for self-diagnosis of the vehicle.

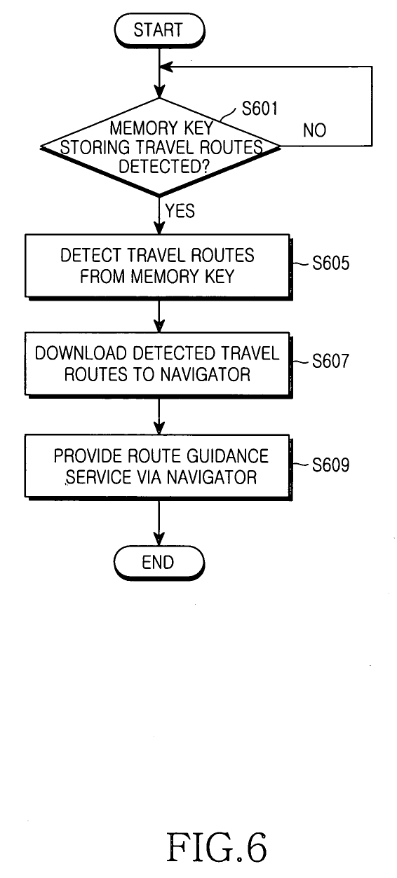

FIG. 6 is a flow chart showing how a navigator is used with reference to information stored in a memory key according to the first and second embodiments of the present invention. The use of the navigator with reference to the information (for example, travel routes) stored in the memory key according to the present invention will now be described with reference to FIG. 6. If a memory reader/writer provided in a vehicle detects a memory key in which travel routes are stored (S601), the memory reader/writer detects the travel routes from the memory key and transfers them to the engine control unit (S605). Then, the engine control unit allows the detected travel routes to be downloaded to the navigator (S607), and provides the corresponding route guidance service via the navigator (S609).

The travel routes stored in the memory key may be frequently used routes or previous routes registered by the user using a computer.

As apparent from the above description, the present invention provides a vehicle key having a memory and a vehicle control method using a vehicle key having a memory that provide at least the following features and advantages. Travel record information or diagnostic information of a vehicle is automatically managed while information of additional services provided in the vehicle is integrated and managed. This maximizes the user's satisfaction with the additional services provided in the vehicle and also provides an improved driving environment to the driver. This induces the driver to safely drive and decreases accident risk due to manipulation of equipment in the vehicle while driving, which consequently reduces traffic accident rates.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention should not be limited to the above embodiments, but is defined by the accompanying claims as well as equivalents thereof.

1. A vehicle key comprising a memory for storing control information for management and control of a vehicle.

2. The vehicle key according to claim 1, wherein the control information includes:
user information including basic personal information and driver's license information;
information of an additional service provided in the vehicle, said service being controllable based on the control information;
travel record information of the vehicle; and
diagnostic information of the vehicle.

3. The vehicle key according to claim 1, wherein the memory stores a plurality of control information items of the control information corresponding to each of a plurality of users.

4. The vehicle key according to claim 3, wherein the vehicle key further includes:
a selection button manipulated by a user to select from among the plurality of control information items;
a display for displaying user identification information corresponding to the control information item selected via the selection button; and
a power supply for supplying power to the display and the memory.

5. The vehicle key according claim 1, wherein the memory is provided in the vehicle key at a predetermined position thereof, said predetermined position corresponding to a portion of the vehicle key to be inserted into an ignition control of the vehicle.

6. A method for controlling a vehicle comprising:
detecting insertion of a vehicle memory key by a memory reader/writer installed in a vehicle and loading control information from a memory of the vehicle memory key, the control information being used to control an additional service provided in the vehicle; and
controlling the additional service using the control information.

7. The method according to claim 6, wherein, if the additional service is an automatic control function of a component of a vehicle, the component is automatically controlled based on the control information.

8. The method according to claim 7, further comprising:
detecting whether a component is manually manipulated by a user or is manipulated using a dedicated control key, controlling the component based on the manipulation, and then updating information in the memory with information of the manipulation.

9. The method according to claim 6, wherein, if the additional service is a function of collecting vehicle travel record and vehicle state information, information corresponding to a preset item for collection is collected, and then the collected information is stored in the memory.
